(19) United States
(12) Patent Application Publication
(10) Pub. No.: US 2003/0212845 A1
(43) Pub. Date: Nov. 13, 2003

(54) Method for high-speed data transfer across LDT and PCI buses

(76) Inventors: John William Court, Carrara (AU); Anthony George Griffiths, Mudgeeraba (AU)

Correspondence Address: GLENN PATENT GROUP, 3475 EDISON WAY, SUITE L, MENLO PARK, CA, 94025, US

(21) Appl. No.: 10/140,583

(22) Filed: May 7, 2002

(51) Int. Cl. G06F 13/14

(52) U.S. Cl. 710/305

(57) ABSTRACT

Systems and methods to control transferring of data across LDT and PCI buses without requiring any high latency read operations. The amount of available receiving buffers on remote processor is written to memory of local processor so that the local processor can determine the number of available receiving buffers on the remote processor. The amount of completed transfers from the local processor is also written to memory of remote processor so that the remote processor can determine the number of completed transfer and process the receiving buffers accordingly and free or reuse the processed buffers.

### CROSS-REFERENCE TO RELATED APPLICATION

This application is related to pending U.S. patent application Ser. No. 09/679,115 filed on Oct. 4, 2000 (Attorney Docket No. AGLE0003).

### TECHNICAL FIELD

The invention relates generally to message communication between processors in a multi-processor computing system, and more particularly to a method to avoid high latency read operations during data transfer using a memory to memory interconnect.

### BACKGROUND OF THE INVENTION

Processors have long been coupled in various network configurations to enhance processing speed, processing power and processor intercommunication. Many such coupling arrangements sacrifice speed as the number of nodes of the processor network increases. Other arrangements couple all or nearly all nodes of the processor network to one another increasing speed at the expense of each node requiring substantial hardware and management expense. Still further prior art arrangements employ high-speed switches interconnecting all network nodes to each other. The switches themselves become complex entities as the number of network nodes increases.

The Peripheral Component Interconnect (PCI) bus technology, which is the current industry standard, typically delivers 133 Mbytes per second. Advanced Micro Devices (AMD) has developed a new bus technology called Lightning Data Transfer (LDT), which is also known as HyperTransport. The LDT chip-to-chip technology offers transmission rates of 1.6 to 6.4 Gbytes per second, depending on factors such as available network bandwidth, device design, and whether the bus is running on a 2, 4, 8, 16- or 32-bit implementation.

LDT bus technology speeds up performance inside PCs and other devices by accelerating data movement between chips equipped with the technology. Typically, devices in a system share a single I/O connection. This makes routing data slower and more difficult because chips must check multiple devices hooked up to the I/O connection before finding the one for which the data is intended. LDT eliminates this problem by offering more I/O connections for devices and by more efficiently and smoothly finding the correct device.

When connecting multiple processor chips via the high-speed bus technology which allows remote memory and device register access, certain operations can impede throughput and waste processor cycles due to latency problems.

The multi-processor computing system disclosed in the pending U.S. patent application Ser. No. 09/679,115, also faces the latency problem. The engine architecture has chips connected via the LDT and PCI buses, both of which support buffered writes which complete asynchronously without stalling the issuing processor. In comparison to writes, reads to remote resources stall the issuing processor until the read response is received. This can be significant in a high-speed, highly pipelined processor, resulting in the loss of compute cycles.

As with any system, operations take finite amounts of time to complete. With buses and devices involved in data transfer, this time is known as latency which is the time period between the time point when a request to perform a function is issued and the time point when it either commences or completes. Generally, memory and cache subsystems are considerably faster than I/O buses, typically by an order of magnitude or more. In an example system such as BCM-12500 SOC (Broadcam Corporation, Irvine, Calif.), the PCI bus is 2 Gbps half-duplex, the LDT bus is 6.4 Gbps full-duplex, and memory operates at up to 50 Gbps and is effectively half-duplex. Based on these values, it is assumed that the inter-connecting bus is the limiting factor in data transfer rather than the memory subsystem at either end.

When transferring a section of memory from one chip to another across a bus, we have the following latency times:

Trm—Time to read a block of local memory (normally a cache line)

Twm—Time to write a block of local memory (also a cache line)

Tbt—Time to transfer the memory block across the bus (assume Tbt>Trm and Tbt>Twm)

Trr—Time to issue a Remote Read request across the bus

If we read N memory blocks from the remote chip's memory system and write them to the local chip's memory, the total time to complete the transfer becomes:

Tr=N*(Trr+Trm+Tbt+Twm)

However, if we write N blocks to the remote memory system rather than read from it, and the transfer bus allows pipelining of write requests, then the total transfer time becomes:

Tv=Trm+N*(Tbt)+Twm

The difference in the total time required to complete the transfer when writing rather than reading is:

(Tr−Tv)=N*Trr+(N−1)*(Trm+Twm)

For small transfers, e.g. N=1, the difference is the time to issue the read request across the bus (Trr). However, as the size of the transfer increases to many blocks, the difference in time increases linearly with the number of blocks of memory transferred. This translates into longer latencies in data transfer and a lower bus utilization. In addition, the local data transfer agent does not need to wait until all of the data has been transferred across the bus and written out to the remote chip's memory system. This means that it is free to initiate the next transfer in somewhat less time than Tw and stalls only when it has filled the available buffer space in the associated bus bridge. Thus, Tw becomes the upper bound on the time that the transfer agent is busy with a particular message.

What is desired is a mechanism for a controlled transferring of data across LDT and PCI buses without requiring any high latency read operations.

### SUMMARY OF THE INVENTION

The invention provides a set of four register counters in each processor and organizes these counters as two pairs, one pair for a transmit channel, i.e. the transmit counters, the other pair for a receive channel, i.e. the receive counters. The pair of transmit counters consists of a transmit counter for the number of transmitted packets by the local processor and a transmit counter for the number of available buffers in the remote processor. The pair of receive counters consists of a receive counter for the number of completed transfers of the remote processor and a receive counter for the number of available buffers on the local processor.

When a communication link is started from a local processor to a remote processor, all counters are initialized to zero. The remote processor allocates receive buffer space locally, updates the value of its receive counter, and writes the value to the transmit counter for available buffers on the local processor. The local processor then starts transferring data packets to the remote processor, incrementing the transmit counter for transmitted packets, and writing this value to the receive counter for completed transfer on the remote processor. The remote processor can determine the number of completed transfers from the receive counters, process these buffers accordingly, and free or reuse these processed buffers.

In a typical embodiment of the invention, each chip of a multiple processor system comprises a data mover, a mailbox register, a general purpose timer, and LDT and PCI bus bridges. The data mover transfers memory from a local chip to a remote chip. The mailbox register generates interrupts to cause the chips to perform certain functions. The general purpose timer keeps track of the state of a communication link and performs house-keeping operations. The LDT or PCI bus bridges receive requests from other components and queue them in internal memory buffers.

Several commands are used to initialize and control a communication link from a local chip to a remote chip. A START command is sent by the first local chip and then by the remote chip. An INIT command is sent by the local chip to cause the remote chip to send a START command thereby synchronizing the communication link. A RUN command is only invoked by the data mover as soon as the communication link is synchronized. A RESET command is sent to set all register counters to zero on both chips once the remote processor is out of sync. A STOP command is sent to cause the remote chip to immediately stop sending traffic across when the system is shutting down.

### BRIEF DESCRIPTION OF THE DRAWINGS

FIG. 1A is a block diagram illustrating an example architecture of a multiprocessor engine comprising a two-dimensional array of 4×4 nodes;

FIG. 1B is a block diagram illustrating the inner structure of a typical node in the PLEX array of FIG. 1A;

FIG. 2 is a block diagram illustrating two processors 112 and 312 which are communicatively coupled to each other via a communication link 115A according to the invention;

FIG. 3A is a block diagram showing register counters contained in the first processor 112;

FIG. 3B is a block diagram showing register counters contained in the second processor 312;

FIG. 4 is a block diagram illustrating the relationships among the transmit counters of the first processor 112 and the receive counters of the second processor 312 when a communication link is established from the first processor 112 to the second processor 312;

FIG. 5A is a flowchart illustrating a process to establish a two-way communication between the first processor 112 and the second processor 312;

FIG. 5B is a flowchart illustrating a process to establish a write-only communication link from the first processor 112 to the second processor 312;

FIG. 5C is a flowchart illustrating a process that the second processor 312 performs when it undergoes initialization;

FIG. 6 is a flowchart illustrating a process that the second processor 312 performs to process buffers;

FIG. 7 is a flowchart illustrating a process to establish a communication link from the second processor 312 to the first processor 112;

FIG. 8 is a block diagram for a multiple-processor system with communication links established according to the invention;

FIG. 9 is a block diagram illustrating the components of each chip in the multiple processor system depicted in FIG. 8;

FIG. 10 is a state transition diagram of the communication link 803 depicted in FIG. 8;

FIG. 11 is a flowchart illustrating a process to establish the communication link 803 according to the invention;

FIG. 12 is a flowchart illustrating a process performed by chip 801 when the communication link is out of sync; and

FIG. 13 is a flowchart illustrating a process performed by chip 801 to stop data transfer across the link.

### DETAILED DESCRIPTION OF THE INVENTION

PLEX Array Architecture of Multiprocessor System

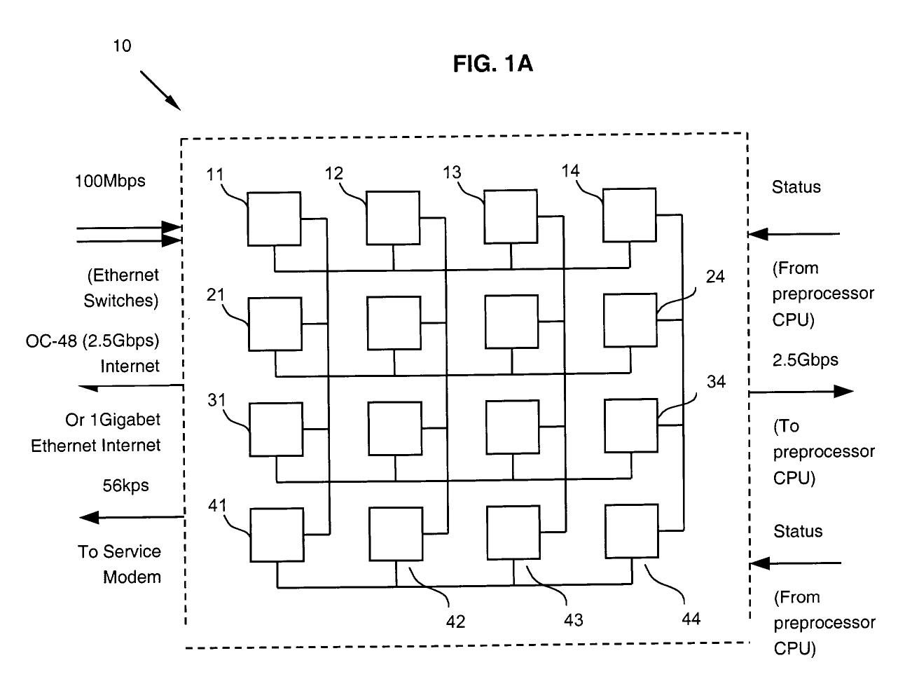

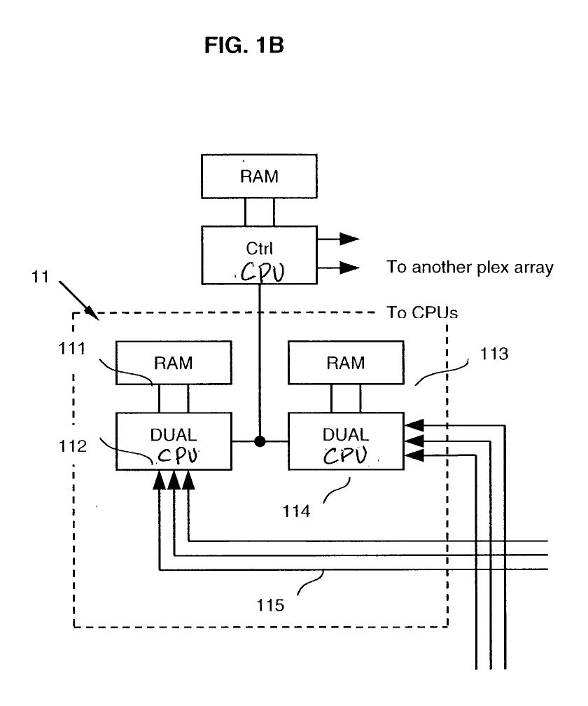

Illustrated in FIG. 1A is an example architecture 10 of a multiprocessor engine comprising a two-dimensional array of 4×4 nodes in accordance with the preferred embodiment. In this architecture, each node is communicatively coupled to the nodes located in a same row with it and to the nodes located in a same column with it. FIG. 1B is a block diagram illustrating the inner structure of node 11 as an example of a typical node in the PLEX array of FIG. 1A. Each node includes two processors 112, 114 and six ports 115. Each processor is coupled to an independent RAM 111, 113 and three ports 115.

The architecture 10 may have M orthogonal directions that support communications between an M dimensional lattice of up to N\hat{ }M nodes, where M is at least two and N is at least four. Each node pencil in a first orthogonal direction contains at least four nodes and each node pencil in a second orthogonal direction contains at least two nodes. Each of the nodes contains a multiplicity of ports.

As used herein, a nodal pencil refers to a 1-dimensional collection of nodes differing from each other in only one dimensional component, i.e. the orthogonal direction of the pencil. By way of example, a nodal pencil in the first orthogonal direction of a two-dimensional array contains the nodes differing in only the first dimensional component. A nodal pencil in the second orthogonal direction of a two-dimensional array contains the nodes differing in only the second dimensional component.

The architecture 10 represents a communications network that is comprised of a communication grid interconnecting the nodes. The communications grid includes up to N\hat{ }(M−1) communication pencils, for each of the M directions. Each of the communication pencils in each orthogonal direction corresponds to a node pencil containing a multiplicity of nodes, and couples every pairing of nodes of the node pencil directly.

As used herein, communication between two nodes of a nodal pencil coupled with the corresponding communication pencil comprises traversal of the physical transport layer(s) of the communication pencil.

Such embodiments of the invention advantageously support direct communication between any two nodes belonging to the same communication pencil, supporting communication between any two nodes in an M dimensional array in at most M hops.

An Algorithm to Avoid High Latency Read Operations During Data Transfer

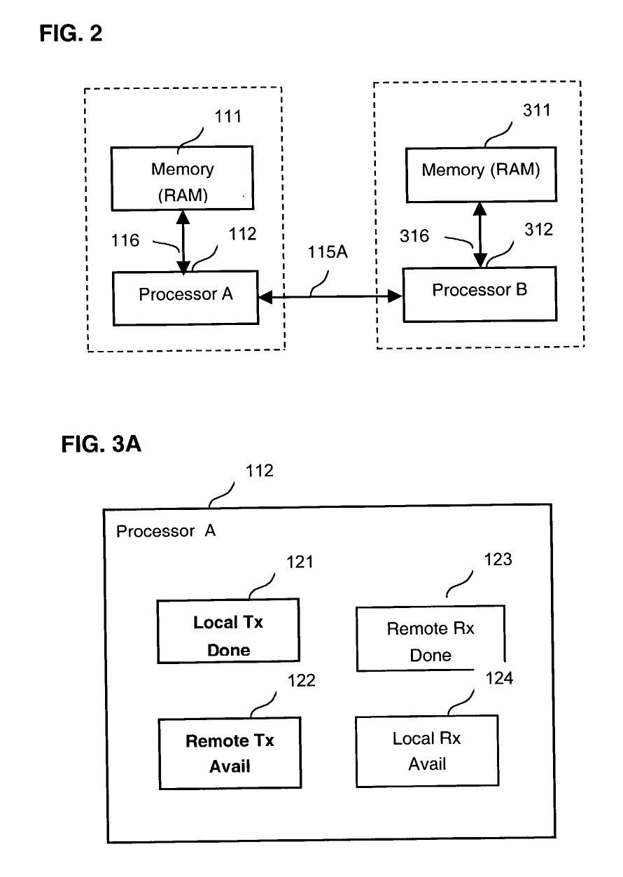

FIG. 2 depicts a two-processor system including the first processor 112 and the second processor 312 which are coupled to each other via a communication link 115A. Processor 112 is accessibly coupled to memory 111 and processor 312 to memory 311. Each processor maintains four register counters organized as two pairs, one pair for a transmit channel and the other for a receive channel.

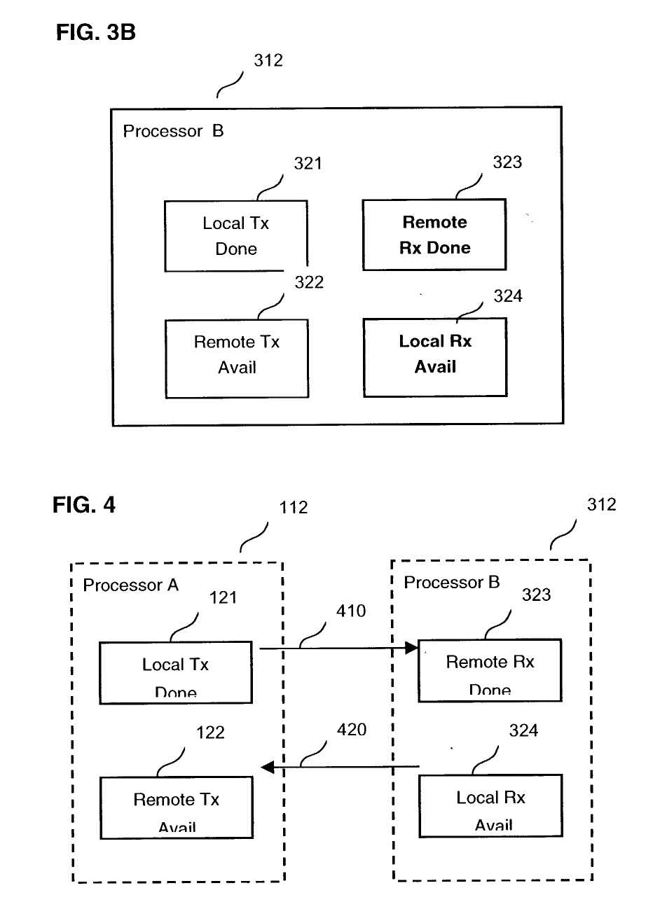

FIG. 3A depicts the register counters contained in the first processor 112. The counters for the processor's transmit channel are “Local Tx Done” 121 and “Remote Tx Avail” 122, and the counters for its receive channel are “Remote Rx Done” 123 and “Local Rx Avail” 124.

FIG. 3B depicts the register counters contained in processor 312. The counters for the processor's transmit channel are “Local Tx Done” 301 and “Remote Tx Avail” 302. The counters for its receive channel are “Remote Rx Done” 303 and “Local Rx Avail” 304.

The “Local Tx Done” counter 121 contains the number of transmitted data packets by processor 112. The “Remote Tx Avail” counter 122 contains the number of available receive buffers in a remote processor such as processor 312. The “Remote Rx Done” counter 123 contains the number of transmitted data packets from the remote processor. The “Local Rx Avail” counter 124 contains the number of available receive buffers on processor 112. The register counters 301, 302, 303 and 304 on processor 312 have the same function as registers 121,122,123, and 124.

The local processor has a read/write access to the “Local Tx Done” and “Local Rx Avail” counters and the remote processor has no access to them. The local processor has read only access to the “Remote Tx Avail” and “Remote Rx Done” counters and the remote processor has write only access to them.

FIG. 4 depicts the relationship of these counters when processor 112 transfers data to processor 312. The value of “Local Tx Done” counter 121 in processor 112 is updated via link 410 to “Remote Rx Done” counter 303 in processor 312. The value of “Local Rx Avail” counter 304 in processor 312 is updated via link 420 to “Remote Tx Avail” counter 122 in processor 112.

The relationship of the transmit counters of processor 312 to the receive counters of processor 112 is the mirror image of the above.

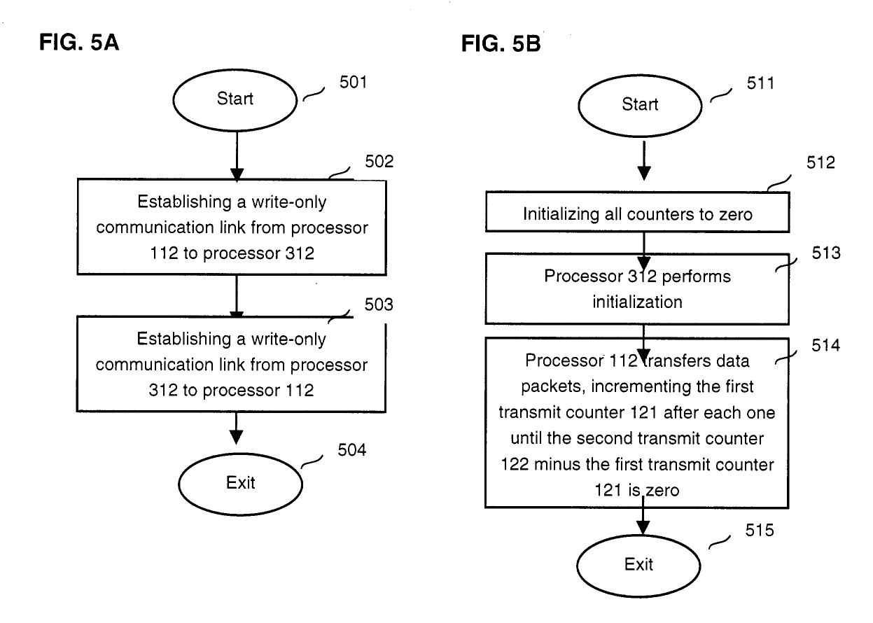

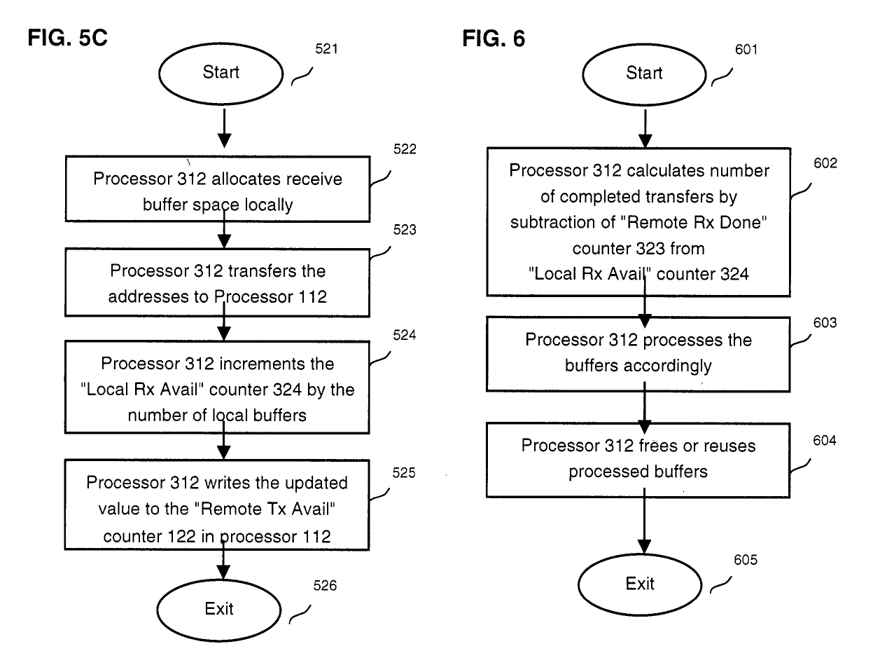

FIG. 5A illustrates a process to establish a two-way communication between processor 112 and processor 312. The process includes the steps of: start 501; establishing a write-only communication link from processor 112 to processor 312 (502); establishing a write-only communication link from processor 312 to processor 112 (503); and exit 504.

FIG. 5B illustrates a process to transfer data from processor 112 to processor 312. The process includes the steps of: start 511; initializing all counters to zero and of such size that they cannot wrap, e.g. 64 bits, 512; performing initialization 513 on processor 312; transferring data packets to processor 312, incrementing the first transmit counter 121 after each one until the second transmit counter 122 minus the first transmit counter 121 is zero (514); and exit 515.

FIG. 5C illustrates the step 513 of FIG. 5B, which further includes: start 521; allocating receive buffers locally by processor 312 (522); transferring the addresses to processor 112 (523); incrementing “Local Rx Avail” counter 304 by the number of receive buffers 524; writing the updated value to “Remote Tx Avail” counter 122 in processor 112 (525); and exit 526.

FIG. 6 illustrates further steps to process receive buffers on processor 312, including: start 601; calculating completed transfers and locating receive buffers 602; processing these buffers accordingly 603; freeing or reusing the processed buffers 604; and exit 605.

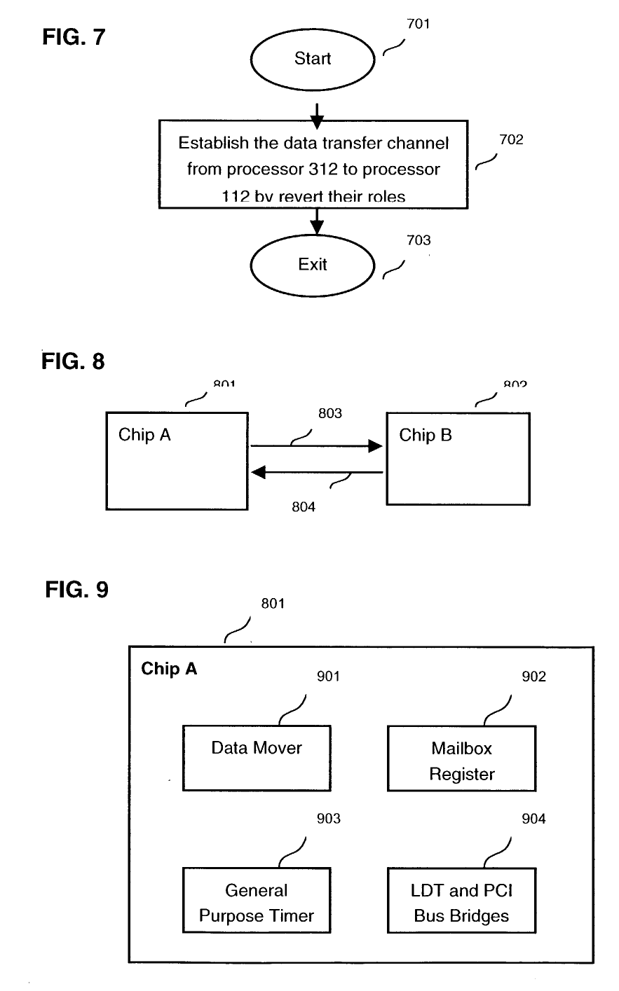

FIG. 7 illustrates a method to establish a communication link from processor 312 to processor 112, including the steps of: start 701; establishing a communication link from processor 312 to processor 112 by exchanging the role of processor 112 and processor 312 (702); and exit 703.

An Example Design of the LDT/PCI Link Driver

The following paragraphs describe a typical embodiment of the invention. The hardware is a multiple-chip processor system. The driver that implements the message-based link protocol according to the method described above is called Link Driver. The system runs on LDT and PCI buses which allow host-to-host data transfers at a very high speed. A specific memory region of each chip can be mapped into the memory space of the remote chip, and writes to the above memory region are automatically transferred across the bus to the remote memory subsystem. Writes to the remote memory can be pipelined thus allowing operations to run at a speed close to maximum bus speed. The hardware also maintains and obeys cache coherency rules on both systems.

An example of local to remote memory address mapping is the physical region from E0_{—}0000_{—}0000 to E0_FFFF_FFFF. This is decoded by the LDT bridge component of the chip and any data access (read or write) is transferred across the bus to the remote bridge. The remote bridge removes the top 8 bits from the address converting it from a 40-bit memory access into a 32-bit access. Thus, as an example, the local chip can access the remote chip's Mailbox register which is at physical address 00_{—}1002_{—}00C0 by using the local physical address E0_{—}1002_{—}00C0. Any addresses within the first 4 GB of the remote chip's address space can be transparently accessed across the bus as if they were connected to the local chip. Here, the speed of access depends on bus transfer rates and timing latencies.

FIG. 8 depicts a two-chip node including chip 801 and chip 802. Communication link 803 is established to transfer data from chip 801 to chip 802, and communication link 804 is established to transfer data from chip 802 to chip 801.

FIG. 9 depicts the components of chip 801, including a Data Mover 901, a Mailbox Register 902, a General Purpose Timer 903 and LDT and PCI bus bridges 904. Chip 802 comprises the same set of components.

The Data Mover 901 is a component of the chip (BCM-12500) which allows an amount of memory up to 1 Megabytes in size to be transferred from a 40-bit physical source address to a 40-bit physical destination address in a single operation. No specific byte alignments are placed on either source or destination. The Data Mover 901 also obeys the cache coherency rules for data transferred using DMA techniques. The Data Mover 901 has significant buffering capacity and can operate in a wide memory bandwidth and at a high speed. The Data Mover 901 operates most efficiently when transferring blocks of memory which are multiples of 32-byte cache lines in length, and where both source and destination are aligned on a 32-byte cache line boundary. The driver takes this into account and, apart from one exception, ensures that all transfers follow the above guideline.

The 64-bit Mailbox Register 902 is broken down into four 16-bit sections. Each section can generate interrupts independent of the other sections. The Link Driver uses one such section for each of the communication channels that are established. Each side of the link writes to the remote mailbox registers while the local side reads and clears its section of the Mailbox. Only during link startup, shutdown, and re-initialization, does the local chip attempt to read from the remote chip's Mailbox. Because this generally occurs only when the operating system is booting, this relatively expensive (in terms of CPU cycles) operation has minimal affect on throughput during normal chip operation.

Each instance of the Link Driver uses the General Purpose Timer (GPT) 903 for keeping track of the link state and for performing house-keeping operations. The 23-bit GPT counter is clocked at 1 Mhz, allowing the driver to implement time intervals from 1 microsecond to approximately 8.3 seconds with a granularity of 1 microsecond.

The LDT and PCI bus bridges 904 implement the bus protocols on one side and the memory access/decode protocols on the other. One or more components can send requests to the bridges and these are queued in internal memory buffers. Multiple reads and writes can be posted and completed in any order although there are well-structured rules for determining when or if reads can overtake writes in the queue ordering. The Link Driver ONLY ever posts writes during normal operation and assumes that these are completed in the order posted, i.e. FIFO. The link driver makes no assumption as to when the written data arrives in the remote chip's memory system. As long as it arrives in-order, the link protocol will be maintained.

Primary Link Data Structure

The primary data structure which allows the link protocol to function is as follows:

typedef struct LDTlink_s {

// Off Access

_V uint64_t RemoteRxAvailable; // +000 L:ro R:wo <--.

_V uint64_t RemoteTxDone; // +008 L:ro R:wo <--|-.

_V uint64_t RemoteRxDone; // +010 L:ro R:wo <--|-|-.

_V uint64_t RemoteTxQueued; // +018 L:-- R:-- | | |

_V void* pRemoteRxBuffers[SBLDT_MAX_BUFFERS]; // +020 L:ro R:wo <--|-|-|-. /* // | | | |

* The following data objects are local to this chip and can be | | | |

* in any order. They are essentially meaningless to the remote chip | | | |

* Obviously, if the same Linux driver is running in each chip than | | | |

* the layout of memory will be symetric. // | | | |

*/ // | | | | |

uint64_t snapLocalRxAvailable; // +120 L:rw R:-- --′ | | |

uint64_t snapLocalTxDone; // +128 L:rw R:-- ----′ | |

uint64_t snapLocalRxDone; // +130 L:rw R:-- -----′ |

uint64_t snapLocalTxQueued; // +138 L:-- R:-- |

uint64_t LocalRxAvailable; // +140 L:rw R: -- |

uint64_t LocalTxDone; // +148 L:rw R:-- |

uint64_t LocalRxDone; // +150 L:rw R:-- |

uint64_t LocalTxQueued; // +158 L:rw R:-- |

void* pLocalRxBuffers [SBLDT_MAX_BUFFERS]; // +160 L:rw R:-- ------′

void* RxBufferCtx [SBLDT_MAX_BUFFERS]; // +260 L:rw R:--

void* TxBufferCtx [SBLDT_MAX_BUFFERS]; // +360 L:rw R:--

sbdmdscr_t DMdscr [SBLDT_MAX_TXDESCR]; // +460 L:rw R:--

} LDTlink_t;

The Link Protocol

The Link Protocol is effectively a WRITE-ONLY protocol by the two peer chips at either end of the inter-connecting bus. Once it has entered the RUNNING state, no reading from remote memory is required. However, strict conformance to the protocol rules is necessary for the link to stay synchronized and to prevent data corruption or loss. Because writes across the bus can be pipelined, latencies are reduced and bus utilization is significantly improved. The following paragraphs describe how the link is kept synchronized.

The first four objects in the above link structure are 64-bit counters. These start at zero and are monotonically incremented while the link is operational. The assumption is that these counters will never overflow no matter how long the link continues to operate or how frequently data packets are being exchanged. Even incremented 1 million times per second, it would take approximately 10**13 seconds or in excess of 100 million days for an overflow to occur in one of these counters. The counters implement a windowing system allowing the communicating peers to be aware of the state of the remote peer at a time in the recent past. It is the responsibility of each side of the link to keep their peer as up to date as possible without using excessive bus bandwidth by transferring newly changed values at every transmission opportunity.

The fifth object in the link structures is an array of buffer addresses provided by the remote chip into which data packets are transferred by the Data Mover under the control of the link driver. Again, the provision of new buffers to replace those consumed should be timely without being done too frequently. Currently, the link driver updates its peer's buffer array after 25% of the allocated buffers have been consumed.

In the following description, the arrows show the transfer of local counters and buffer pointers across to the remote chip's memory. The type of access to each component of the link structure by these two chips is also provided for clarity. The letter L refers to Local host access, while R means Remote host access. The access codes are:

ro Read Only

rw Read/Write

wo Write Only

-- No Access

The remaining objects in the link structure are only meaningful to the local host, and there is no implicit ordering required by the link protocol.

To make computations easier, the message buffer window size has been set at a power of 2, specifically 64 (hex 0x40). The index of any particular message in the buffer array is computed via (counter & 0x3F). For example:

index=LocalRxDone & 0x3F

A transmitting chip can determine the number of messages in the communication pipe via:

msgs_in_pipe=LocalTxQueued−RemoteRxDone

This value should never exceed the number of available buffers or a data overrun or message corruption in the receiver is likely to occur. Since the receiving chip is responsible for allocating receive buffers (RemoteRxAvailable) and incrementing the RemoteRxDone counter and both sides have agreed on the window size beforehand, the receiver will implicitly throttle the link to a data rate with which it can cope. The number of free receive buffers is computed via:

free rx_bufs=RemoteRxAvailable−LocalTxQueued

while the number of buffers into which messages have been transferred by the peer and which are awaiting receive processing is:

msgs_in_bufs=RemoteTxDone−LocalRxDone

The relationships between the local and remote counters is:

LocalTxQueued<=RemoteRxAvailable

LocalRxDone<=RemoteTxDone

Other counter values, e.g. RemoteRxDone, exist as an optimization to the transfer protocol. If RemoteRxDone is not incrementing and the local chip notices that the remote chip is not processing receive packets in a timely fashion, it can explicitly request its peer to run and process any queued packets by setting the appropriate bit(s) in the Mailbox register. This forces an interrupt on the peer chip with the expectation that the Interrupt Service Routine (ISR) performs those functions needed to keep the link running. General Purpose Timer 903 is used by the link driver to determine if progress is being made.

Link Initialization and Control Commands

The communications link is initialized by way of the remote Mailbox register. It is used because of the interrupt capability that guarantees a speedy processing of the command that was issued. An alternative is to use a shared memory location, but that requires polling to detect newly issued commands. The link control commands STOP, RESET, START, and INIT are all issued via Programmed-IO (PIO) data transfers, and all require reading of the remote Mailbox to ensure that the previous command has been serviced except for STOP which can be issued at any time since it will override any previously issued command. The RUN command is only issued once the protocol is synchronized and only by the Data Mover. The CPU never issues this command directly.

The format of the five commands and their bit encoding is:

STOP 0xDEAD

RESET 0xC000

START 0x8yyy

INIT 0x4000

RUN 0x0001

The top two bits of the 16-bit Mailbox segment determine the command that has been issued except for the overlap between STOP and RESET where both have the two top bits set but the latter differs from the former in the low 14-bits. Also, when the STOP command is logically OR'd with any of the other commands, the resulting bit pattern remains that of the STOP command. This is important since a write to the Mailbox Register 902 is in reality a logical OR of the new bit pattern with any existing bit pattern.

The START command provides 14 bits of data which is the Megabyte-aligned starting address of the link structure described above. This allows the link structure to be located anywhere within the first 34 bits (16 GB) of the 40-bit physical address space of the chips. Currently, all required resources are located within the first 4 GB of address space. The START command is issued when the link driver is brought up by a management command (ifconfig) or by the receipt of an INIT command from the peer chip. The link enters the STARTING state after issuing a START or the RUNNING state after receiving a START.

The INIT command is used when a chip has previously issued a START command to its peer and is itself awaiting a START command giving it the base address of the peer's link structure. Generally, this command will be issued from within a poll timer function. Receiving an INIT command should cause the chip to issue a corresponding START command to it's peer thereby synchronizing the link and bring it into the RUNNING state.

The RESET command is available when a chip determines that its peer is out of sync. Both chips should zero their counters and transition to the STARTING state.

Finally, the last of the PIO commands is the STOP command, which causes the peer to immediately stop sending traffic across the bus. It is expected that this command will be issued only when the system is shutting down or when the link driver detects a fatal protocol error from which there is no automatic recovery.

Each communication link uses a General Purpose Timer (GPT). The GPT is used to ensure that the transmitted data packets are processed by the remote peer in the situation where there is very little two-way traffic. The timer is currently set to expire after 500 microseconds and is operated as follows:

When the driver receives a packet for transmission, it queues it to the Data Mover and starts, if not already running, the GPT with a timeout of 500 us. If the timer was running, it is left running. Any newly arrived received packets are processed and the updated counters are sent across to the peer.

If another packet is sent to the transmit function of the driver, it does as above. However, a check is made to see if the remote peer has processed some additional, but not necessarily all, previously transmitted packets. If it has, the timer is stopped. If not all transmitted packets or packets queued for transmission have been processed, then the GPT is restarted with the initial 500 us timeout value.

If the GPT expires and interrupts, then an explicit RUN command is queued to the Data Mover. This sets the run bit in the remote Mailbox register which in turn causes an interrupt in the remote CPU. The ISR routine is executed and it completes any received packets, updates counter values, and queues them to its Data Mover for transmission to its peer.

As both sides are executing the above, GPT and Mailbox interrupts should only occur when one side ceases transmitting packets to the other. If both are transmitting packets on a frequent basis (<500 us), then both see the other side processing their received packets and both stop and, if necessary, restart their GPT with its initial value. Given enough two-way traffic, very few GPT interrupts should occur and very few RUN commands should be sent to the remote CPU.

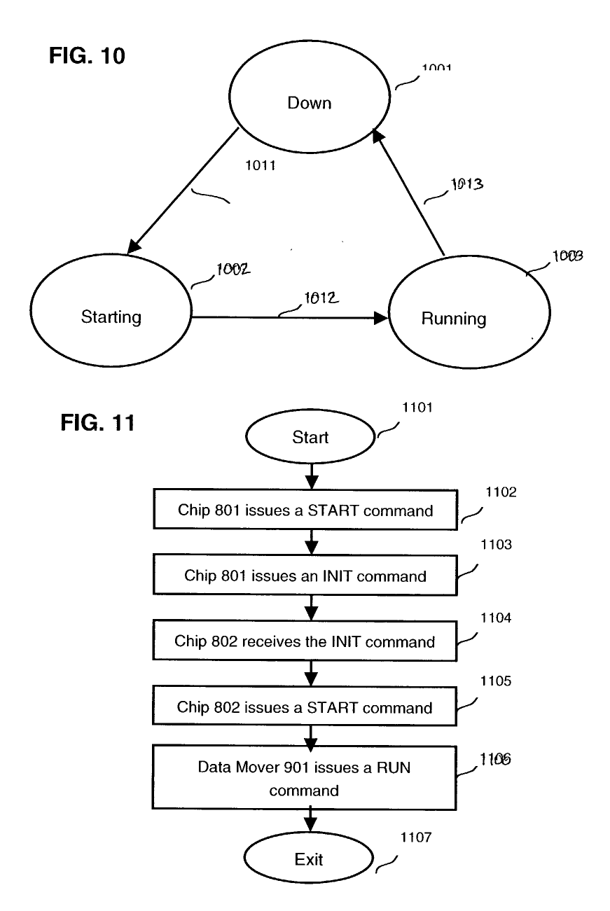

FIG. 10 depicts a state transition diagram of the communication link 803. The link 803 is initially in a “Not Started” state 1001. After chip 801 issues a START command 1011, the link 803 enters “Starting” state 1002. After receiving an INIT command, the chip 802 will issue a START command 1012, and the link 803 enters “Running” state 1003 after receiving the START command. A STOP command 1013 stops the link 803 and the link 803 changes back to “Not Started” state 1001. The same type of state transition happens in each communication link.

FIG. 11 depicts a flowchart for a process to establish the communication link 803. The process includes the steps of: start 1101; issuing a START command by chip 801 (1102); issuing an INIT command by chip 801 (1103); receiving an INIT command by chip 802 (1104); issuing a START command by chip 802 (1105); issuing a RUN command by Data Mover 901 (1106); and exit 1107.

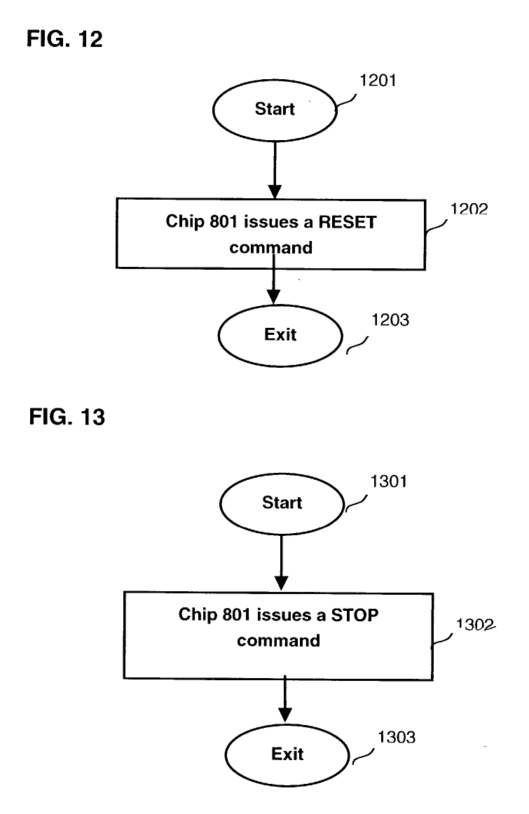

FIG. 12 depicts a flowchart for a process to reset the communication link 803 when the peer chip is out of sync. The process includes the steps of: start 1201; issuing a RESET command by chip 801 (1202); and exit 1203.

FIG. 13 depicts a flowchart for process to shut down the communication link 803 when the system is shutting down or when the link driver detects a fatal protocol error from which there is no automatic recovery. The process includes the steps of: start 1301; issuing a STOP command by chip 801 (1302); and ext 1303.

The methods described herein can be embodied in a set of computer readable instructions or codes which can be stored in any computer readable storage medium and can be transferred and downloaded over the Internet.

Although the invention is described herein with reference to the preferred embodiment, one skilled in the art will readily appreciate that other applications may be substituted for those set forth herein without departing from the spirit and scope of the present invention.

Accordingly, the invention should only be limited by the claims included below.

1. A multiple processor system containing at least two processors, wherein each of said processors comprises:
a pair of transmit counters for a transmit communication channel;
a pair of receive counters for a receive communication channel; and
a write-only communication link from a first processor to a second processor, said first processor transferring packets to said second processor via said communication link.

2. The system of claim 1, wherein said pair of transmit counters on said first processor comprises:
a first transmit counter which contains the number of transmitted data packets for said first processor; and
a second transmit counter which contains the number of available receive buffers for said second processor.

3. The system of claim 2, wherein said pair of receive counters on said second processor comprises:
a first receive counter which contains the number of completed transfers for said first processor; and
a second receive counter which contains the number of available receive buffers for said second processor.

4. The system of claim 3, wherein said first transmit counter in said first processor writes its current value to said first receive counter in said second processor after each data transfer from said first processor.

5. The system of claim 4, wherein said second receive counter in said second processor writes its current value to said second transmit counter in said first processor when receiving buffers are freed or reused on said second processor.

6. The system of claim 1, further comprising:
a second write-only communication link from said second processor to said first processor, said second processor transferring data packets, to said first processor via said second communication link.

7. A method for establishing a two-way communication link between a first processor and a second processor, both processors maintaining a pair of transmit counters for a transmit communication channel and a pair of receive counters for a receive communication channel, said method comprising the steps of:
establishing a first write-only communication link from said first processor to said second processor; and
establishing a second write-only communication link from said second processor to said first processor.

8. The method of claim 7, wherein said pair of transmit counters on said first processor comprises:
a first transmit counter which contains the number of transmitted data packets for said first processor; and
a second register counter to contain the number of available receive bufers for said second processor.

9. The method of claim 8, wherein said pair of receive counters on said second processor comprises:
a first receive counter which contains the number of completed transfers for said first processor; and
a second receive counter which contains the number of available receive buffers for said second processor.

10. The method of claim 9, wherein the step of establishing a first write-only communication link from said first processor to said second processor further comprises the steps of:
initializing all counters on said first processor and said second processor to zero;
performing initialization by said second processor; and
transferring data packets from said first processor to said second processor, wherein said processor increments said first transmit counter after each transfer until said second transmit counter minus said first transmit counter is equal to zero.

11. The method of claim 10, wherein said step of performing initialization by said second processor further comprises the steps of:
allocating receive buffer space locally by said second processor;
transferring the allocated addresses to said first processor;
incrementing said second receive counter on said second processor by the number of local buffers; and
writing the updated value of said second receive counter on said second processor to said second transmit counter on said first processor.

12. The method of claim 10, wherein the step of establishing a write-only communication link from said first processor to said second processor further comprises the steps of:
calculating, by said second processor, the number of completed transfers by subtraction of said first receive counter on said second processor from said second receive counter on said second processor;
processing, by said second processor, said buffers according to the result of said step of calculating; and
freeing or reusing processed buffers by said second processor.

13. The method of claim 9, wherein the step of establishing a write-only communication link from said second processor to said first processor further comprises the steps of:
performing initialization by said first processor; and
transferring data packets from said second processor to said first processor, wherein said second processor increments said first transmit counter after each transfer until said second transmit counter minus said first transmit counter is equal to zero.

14. A multiple processor system, comprising:
a first chip; and
a second chip:
wherein a first substantially write-only communication link is established from said first chip to said second chip using a write-only message-based link protocol.

15. The system of claim 14, wherein each chip comprises:
means to transfer memory from one chip to another chip;
means to generate interrupts guaranteeing a speedy processing of issued commands;
means to keep track of link state and perform house-keeping operations; and
means to receive requests from other components and queue requests in internal memory buffers.

16. The system of claim 15, wherein said means to transfer memory is a data mover.

17. The system of claim 15, wherein said means to generate interrupts is a remote mailbox register.

18. The system of claim 15, wherein said means to keep track of link state is a general purpose timer.

19. The system of claim 15, wherein said means to receive requests is Lightning Data Transfer or Peripheral Component Interconnect bus bridges.

20. The system of claim 15, wherein said write-only message-based link protocol uses a link structure comprising:
four 64-bit counters starting at zero;
a list of buffer addresses provided by a remote chip into which data packets are transferred by said means to transfer memory; and
other information only accessible to said first chip.

21. The system of claim 20, wherein said 64-bit counters are incremented monotonically and never overflow while said link is operational.

22. The system of claim 15, wherein said communication link is established using link initiation and control commands, said control commands comprising:
a start command to start up said communication link;
an init command to synchronize said communication link;
a run command to start data transferring after said communication link is synchronized;
a reset command to rest both chip counters to zero when a chip determines its peer is out of sync; and
a stop command to cause a remote peer chip to immediately stop sending data across.

23. The system of claim 14, wherein a second substantially write-only communication link is established from said second chip to said first chip using said link protocol.

24. A method for establishing a write-only communication link from a first chip to a second chip using a link driver wherein each chip comprising a means to transfer memory, a means to generate interrupt, a means to keep track of said link, and a means to receive requests, said method comprising the steps of:
said first chip sending a start command to notify said second chip that said first driver is starting;
said first chip sending an init command to said second chip to synchronize said communication link;
said second chip receiving said init command from said first chip;
said second chip sending a start command to synchronize said communication link; and
said means to transfer memory sending a run command to start data transferring across said communication link.

25. The method of claim 24, wherein said means to transfer memory is a data mover.

26. The method of claim 24, wherein said means to generate interrupts is a remote mailbox register.

27. The method of claim 24, wherein said means to keep track of link state is a general purpose timer.

28. The method of claim 24, wherein said means to receive requests is Lightning Data Transfer or Peripheral Component Interconnect bus bridges.

29. The method of claim 24, wherein said link driver uses a link structure comprising:
four 64-bit counters starting at zero;
a list of buffer addresses provided by a remote chip into which data packets are transferred by said means to transfer memory; and
other information only accessible to said first chip.

30. The method of claim 29, wherein said 64-bit counters are incremented monotonically and never overflow while said link is operational.

31. The method of claim 28, further comprising the step of:
sending, by said first chip, a reset command to set all counters of both chips to zero when said first chip determines said second chip is out of sync.

32. The method of claim 24, further comprising the step of:
sending, by first chip, a stop command to cause said second chip to immediately stop sending data packets across said link.

33. The method of claim 24, wherein said communication link changes to a starting state after said first chip sending a start command.

34. The method of claim 24, wherein said communication link changes to a running state after said second chip sending a start command.

35. The method of claim 32, wherein said communication link changes to a not running state after said first chip sending a stop command.

36. The method of claim 32, wherein said communication link changes to a starting state after said first chip sending a reset command.

37. The method of claim 27, wherein said timer is started if said timer is not already running when said driver receives a data packet for transmission.

38. The method of claim 37, wherein said timer is started if said timer is not already running when a data packet is sent to a transmit function of said driver.

39. The method of claim 38, wherein said timer is stopped if a remote chip has processed some additional, but not necessarily all, previously transmitted data packet.

40. The method of claim 39, wherein said timer is restarted if not all transmitted data packets or packets queued for transmission have been processed by said remote chip.

41. The method of claim 27, wherein said timer has a value of 500 microseconds.

42. The method of claim 40, wherein said timer expires and interrupts and an explicit run command is queued to said means to transfer memory to cause said remote chip to process transmitted data packets.

43. A computer readable storage medium containing a computer readable code for operating a computer system to implement a method for establishing a two-way communication link between a first processor and a second processor, both-processors maintaining a pair of transmit counters for a transmit communication channel and a pair of receive counters for a receive communication channel, said method comprising the steps of:
establishing a first write-only communication link from said first processor to said second processor; and
establishing a second write-only communication link from said second processor to said first processor.

44. The computer readable storage medium of claim 43, wherein said pair of transmit counters on said first processor consists of:
a first transmit counter which contains the number of transmitted data packets for said first processor; and
a second register counter to contain the number of available receives for said second processor.

45. The computer readable storage medium of claim 44, wherein said pair of receive counters on said second processor consists of:
a first receive counter which contains the number of completed transfers for said first processor; and
a second receive counter which contains the number of available receives for said second processor.

46. The computer readable storage medium of claim 45, wherein the step of establishing a first write-only communication link from said first processor to said second processor further comprises the steps of:
initializing all counters on said first processor and said second processor to zero;
performing initialization by said second processor; and
transferring data packets from said first processor to said second processor, wherein said processor increments said first transmit counter after each transfer until said second transmit counter minus said first transmit counter is equal to zero

47. The computer readable storage medium of claim 46, wherein said step of performing initialization by said second processor further comprises the steps of:
allocating receive buffer space locally by said second processor;
transferring the allocated addresses to said first processor;
incrementing said second receive counter on said second processor by the number of local buffers; and
writing the updated value of said second receive counter on said second processor to said second transmit counter on said first processor.

48. The computer readable storage medium of claim 46, wherein the step of establishing a write-only communication link from said first processor to said second processor further comprises the steps of:
calculating, by said second processor, the number of completed transfers by subtraction of said first receive counter on said second processor from said second receive counter on said second processor;
processing, by said second processor, said buffers according to the result of said step of calculating; and
freeing or reusing processed buffers by said second processor.

49. The computer readable storage medium of claim 45, wherein the step of establishing a write-only communication link from said second processor to said first processor further comprises the steps of:
performing initialization by said first processor; and
transferring data packets from said second processor to said first processor, wherein said second processor increments said first transmit counter after each transfer until said second transmit counter minus said first transmit counter is equal to zero.

50. The computer readable storage medium of claim 43 wherein said computer readable code can be downloaded over the Internet.

51. A computer readable storage medium containing a computer readable code for operating a computer system to implement a method for establishing a write-only communication link from a first chip to a second chip using a link driver wherein each chip comprising a means to transfer memory, a means to generate interrupt, a means to keep track of state of said write-only communication link, and a means to receive requests, said method comprising the steps of:
said first chip sending a start command to notify said second chip that said first driver is starting;
said first chip sending an init command to said second chip to synchronize said communication link;
said second chip receiving said init command from said first chip;
said second chip sending a start command to synchronize said communication link; and
said means to transfer memory sending a run command to start data transferring across said communication link.

52. The computer readable storage medium of claim 51, wherein said means to transfer memory is a data mover.

53. The computer readable storage medium of claim 51, wherein said means to generate interrupts is a remote mailbox register.

54. The computer readable storage medium of claim 51, wherein said means to keep track of link state is a general purpose timer.

55. The computer readable storage medium of claim 51, wherein said means to receive requests is Lightning Data Transfer or Peripheral Component Interconnect bus bridges.

56. The computer readable storage medium of claim 51, wherein said link driver uses a link structure comprising:
four 64-bit counters starting at zero;
a list of buffer addresses provided by a remote chip into which data packets are transferred by said means to transfer memory; and
other information only accessible to said first chip.

57. The computer readable storage medium of claim 56, wherein said 64-bit counters are incremented monotonically and never overflow while said link is operational.

58. The computer readable storage medium of claim 55, further comprising the step of:
sending, by said first chip, a reset command to set all counters of both chips to zero when said first chip determines said second chip is out of sync.

59. The computer readable storage medium of claim 51, further comprising the step of:
sending, by first chip, a stop command to cause said second chip to immediately stop sending data packets across said link.

60. The computer readable storage medium of claim 51, wherein said communication link changes to a starting state after said first chip sending a start command.

61. The computer readable storage medium of claim 51, wherein said communication link changes to a running state after said second chip sending a start command.

62. The computer readable storage medium of claim 59, wherein said communication link changes to a not running state after said first chip sending a stop command.

63. The computer readable storage medium of claim 59, wherein said communication link changes to a starting state after said first chip sending a reset command.

64. The computer readable storage medium of claim 54, wherein said timer is started if said timer is not already running when said driver receives a data packet for transmission.

65. The computer readable storage medium of claim 64, wherein said timer is started if said timer is not already running when a data packet is sent to a transmit function of said driver.

66. The computer readable storage medium of claim 65, wherein said timer is stopped if a remote chip has processed some additional, but not necessarily all, previously transmitted data packet.

67. The computer readable storage medium of claim 66, wherein said timer is restarted if not all transmitted data packets or packets queued for transmission have been processed by said remote chip.

68. The computer readable storage medium of claim 54, wherein said timer has a value of 500 microseconds.

69. The computer readable storage medium of claim 67, wherein said timer expires and interrupts and an explicit run command is queued to said means to transfer memory to cause said remote chip to process transmitted data packets.

70. The computer readable storage medium of claim 51, wherein said computer readable code can be downloaded over the Internet.
